(19) United States
(12) Patent Application Publication
(10) Pub. No.: US 2009/0083092 A1
(43) Pub. Date: Mar. 26, 2009

(54) METHOD AND SYSTEM FOR GENERATING A TASK LIST IN AN ENTERPRISE SYSTEM

(76) Inventors: MARCO VALENTIN, Malsch (DE); Christian Gaertner, Oestringen (DE); Stefan Tex, Pfinztal (DE)

Correspondence Address: SAP AG, 3410 HILLVIEW AVENUE, PALO ALTO, CA, 94304, US

(21) Appl. No.: 11/860,547

(22) Filed: Sep. 25, 2007

(51) Int. Cl. G06F 17/30

(52) U.S. Cl. 705/7

(57) ABSTRACT

Disclosed is a method and system for defining a step of a business scenario, converting the step to a business process executable in an enterprise system and generating a task list containing a list of business processes in the business scenario.

### FIELD OF THE INVENTION

The invention generally relates to the field of enterprise resource planning application and more specifically to generation of a task list for a business scenario in an enterprise system.

### BACKGROUND OF THE INVENTION

A business scenario such as upgrading a software program in an enterprise system typically involves a number of steps to be performed. It is often challenging to determine necessary set of steps to be performed. It may be necessary to obtain details such as an order in which the step has to be processed, if the step is a mandatory step, input parameters of the step, a location of an error fix if an error in the software program has to be fixed before the software program is upgraded, and a location of the update pack. Once, the necessary step to be performed is determined, to implement the upgrade in the enterprise system it may be challenging for a user to map the step to a business process in the enterprise system that performs a functionality of the step. Mapping the step to the business process in enterprise system may be challenging as the enterprise system is typically a complex system with a number of applications and components. Also, a name of the business process may not directly imply the functionality of the business process. For example, a business process by name SALES_{—}001 may provide a functionality to retrieve sales order for a particular customer, updating the sales order, generate a sales report of an organization or for a subsidiary of an organization. In such cases, the user may have to spend more time to obtain a description of the business process which may be done by retrieving a description attribute of the business process.

Typically a significant amount of time and effort is spent by the user to identify the business process in the enterprise system that performs a functionality of the step of the business scenario. Also, the amount of time and effort involved may also increase if the business scenario is implemented in a number of enterprise systems as the process needs to be repeated. Every time the business scenario is implemented in the enterprise system, the user has to make sure that all necessary steps of the business scenario are processed since the steps are processed by the user manually. Even after doing this, the user may not be sure whether all the necessary steps have been performed. This method of executing a business scenario in the enterprise system is prone to error and time consuming.

### SUMMARY OF THE INVENTION

What is described is a method and system for defining a step of a business scenario, converting the step to a business process executable in an enterprise system and generating a task list containing a list of business processes in the business scenario. The step of the business scenario may be defined in a file such as an extensible markup language (XML) file which is converted to the business process executable in the enterprise system.

### BRIEF DESCRIPTION OF THE DRAWINGS

FIG. 1 is a flow diagram for generating a task list in an enterprise system according to an embodiment of the invention.

FIG. 2 is a flow diagram for converting a step of the business scenario defined in a file to a business process executable in the enterprise system according to an embodiment of the invention.

FIG. 3 is an example extensible markup language (XML) file containing the definition of a step of the business scenario according to an embodiment of the invention.

FIG. 4 is an example screen display of a task list generated in the enterprise system according to an embodiment of the invention.

FIG. 5 is a block diagram of a business process creating tool to generate a task list of business processes executable in the enterprise system according to an embodiment of the invention.

FIG. 6 is a detailed block diagram of various components of a business process creating tool to generate a task list of business processes executable in the enterprise system according to an embodiment of the invention.

### DETAILED DESCRIPTION

What is described is a method and system for defining a step of a business scenario, converting the step to a business process executable in an enterprise system and generating a task list containing a list of business processes in the business scenario. The step of the business scenario may be defined in a file such as an extensible markup language (XML) file which is converted to the business process executable in the enterprise system.

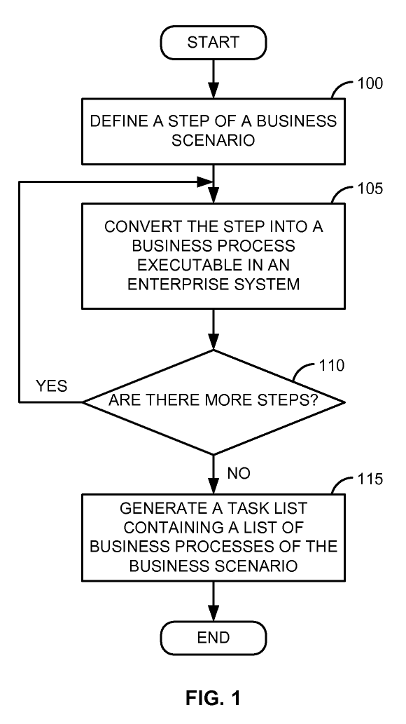

FIG. 1 is a flow diagram for generating a task list in an enterprise system according to an embodiment of the invention. At process block 100 a step of a business scenario is defined. Defining the step of the business scenario includes determining an attribute of the step such as a name of the step, a type of the step, an execution order of the step, an application to which the step belongs and a component to which the step belongs. The step of the business scenario may be defined in a file such as an XML file.

At process block 105, the step of the business scenario is converted to a business process executable in the enterprise system. At decision block 110 it is checked if there are more steps of the business scenario to be converted. If yes, then process block 105 is executed. If there are no more steps of the business scenario to be converted, then a task list containing a list of business processes of the business scenario is generated in the enterprise system as depicted in process block 115.

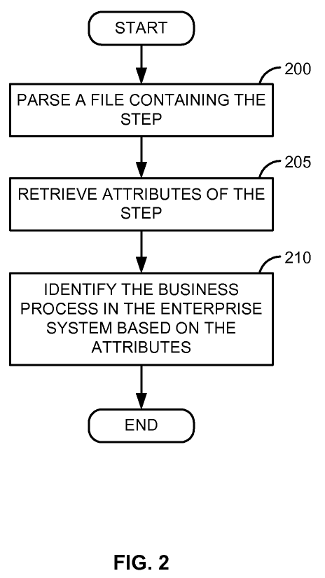

FIG. 2 is a flow diagram for converting a step of the business scenario defined in a file to a business process executable in the enterprise system according to an embodiment of the invention. At process block 200, the XML file containing a definition of the step of the business scenario is parsed. At process block 205 attributes of the step are retrieved. The attributes of the step such as a name of the step, a type of the step, an application to which the step belongs, and a component to which the step belongs are retrieved from the XML file. At process block 210, the business process in the enterprise system is identified based on the name, the type, the application to which the step belongs and the component to which the step belongs.

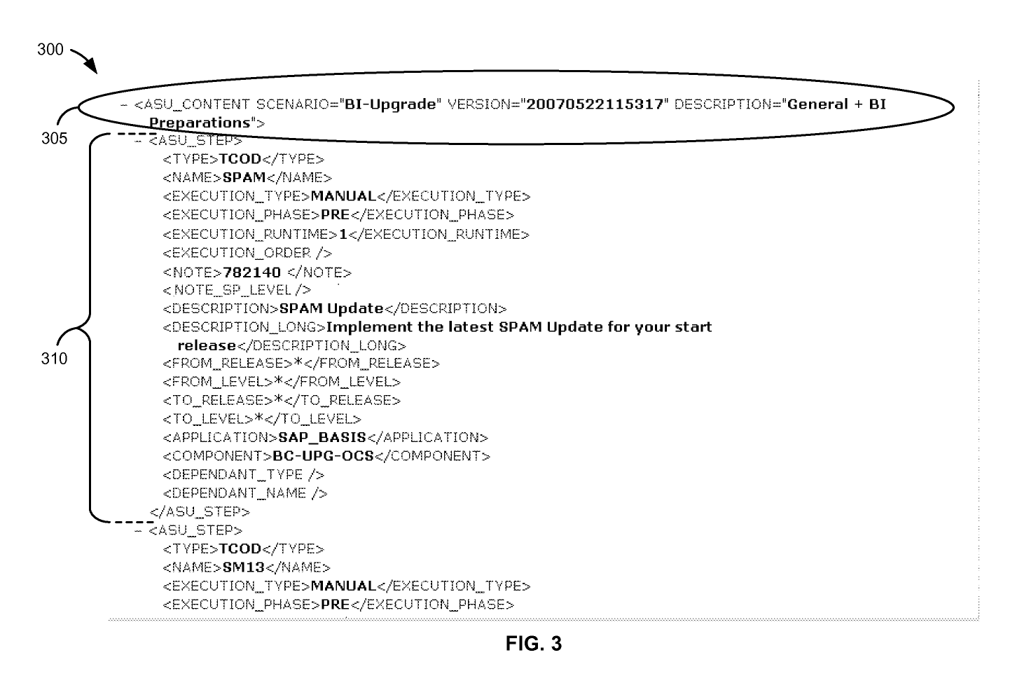

FIG. 3 is an example XML file containing the definition of a step of the business scenario according to an embodiment of the invention. XML file 300 contains the definition of business scenario 305. Business scenario 305 is a scenario for upgrading a business intelligence enterprise system. XML file 300 defines step 310 of the business scenario 305. Step 310 performs an update to a spam program in the enterprise system. Attributes such as a type of the step, a name of the step, an execution type of the step, an execution order of the step, an application to which the step belongs, and a component to which the step belongs are defined in step 310.

“<TYPE>” attribute in step 310 contains a type identification (ID) of the step. Various types of the step may include a report generation, a report generation with a selection screen wherein the report accepts an input from a user, a database update, a process executed to initiate a service in the enterprise system, and executing a note that contains information about error fixes for a software object. In an embodiment “<TYPE>” attribute has a value “TCOD” in step 310 which specifies that step 310 is a transaction code of a particular business process in the enterprise system. “<NAME>” attribute in step 310 indicates a name of step 310. “<EXECUTION_TYPE>” attribute has values such as automatic and manual which specifies whether step 310 is executed automatically or manually.

“<EXECUTION_PHASE>” attribute in step 310 has values such as pre and post. “<EXECUTION_PHASE>” attribute specifies a phase at which step 310 may be processed, that is, before or after execution of a particular business scenario. In an embodiment a business scenario could be implementing a note for upgrading a business intelligence enterprise system. “<EXECUTION_RUNTIME>” contains a value that ranges from 0 to 4 indicating the priority of execution of step 310. The value, 0 indicates “not defined”, 1 indicates “low”, 2 indicates “medium”, 3 indicates “high” and 4 indicates “very high”. Typically, “<EXECUTION_RUNTIME>” attribute applies to steps that have an “<EXECUTION_TYPE>” as automatic. “<EXECUTION_ORDER>” specifies an order in which step 310 may be executed among all steps of business scenario 305. “<EXECUTION_ORDER>” contains a value ranging from 1 to 999 where 1 indicates that a step may be executed first. If no value is specified for “<EXECUTION_ORDER>” then the step may be executed in any order.

<NOTE> attribute specifies a note ID of a note. The note contains a business specific information regarding a software object such as features of the software object, limitations of the software object, probable release date of a next version of the software object, installation procedure, troubleshooting procedure, error fixing procedure, and attachments of the software object with error fixes. “<DESCRIPTION>” attribute has a description of step 310. “<DESCRIPTION_LONG>” attribute contains a brief description of step 310, typically longer than the description specified in “<DESCRIPTION>” attribute. Attributes “<FROM_RELEASE>” and “<FROM_LEVEL>” specifies a release number and a release level number of a software program executing business scenario 305 from which step 310 is applicable. Attributes “<TO_RELEASE>” and “<TO_LEVEL>” specifies a release number and a release level number of the software program until which step 310 is applicable.

Attribute “<APPLICATION>” specifies an application to which step 310 belongs and attribute “<COMPONENT>” specifies a component to which step 310 belongs. Typically, there may be a step that is dependent on another step. Attribute <DEPENDENT_TYPE> specifies a type of the step dependent on step 310. Attribute <DEPENDENT_NAME> specifies a name of the step dependent on step 310. In an embodiment, the definition of step 310 may contain more attributes than specified in XML file 300. In an embodiment, business scenario 305 may contain more than one step.

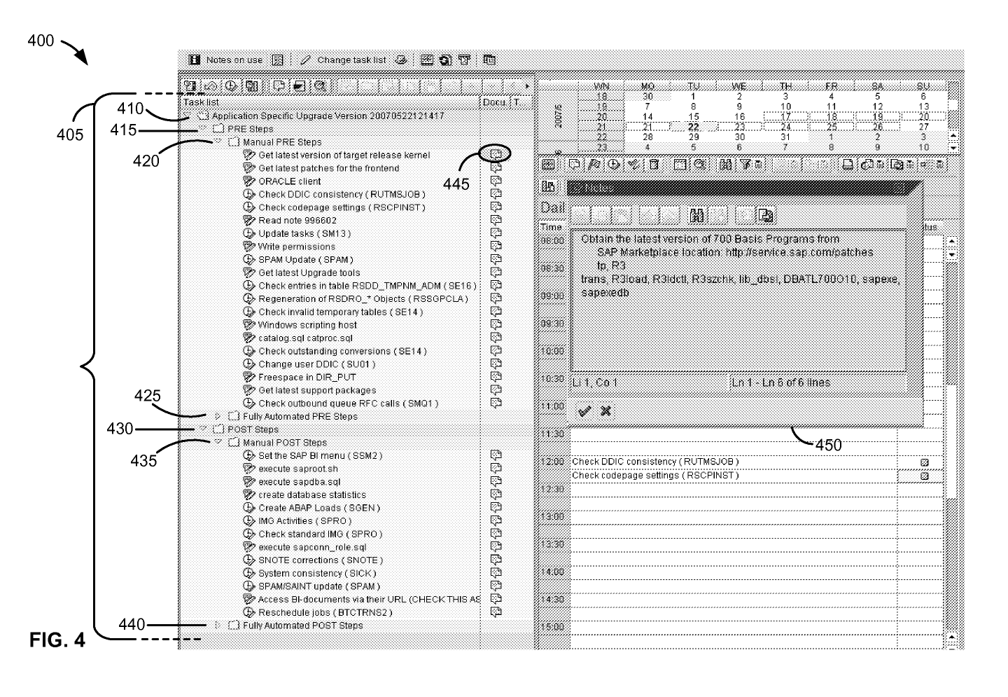

FIG. 4 is an example screen display of a task list generated in the enterprise system according to an embodiment of the invention. User interface 400 contains task list 405 for business scenario 410. Task list 405 contains a set of tasks which are business processes executable in the enterprise system. The business processes are converted from the steps defined in XML file 300. Tasks in task list 405 are categorized into pre steps 415 and post steps 430. The tasks in pre steps 415 are executed prior to execution of a business scenario. In an embodiment, business scenario 410 may be a scenario for upgrading a business intelligence system via implementation of a note. The tasks in post steps 430 are executed post the execution of the business scenario. The tasks in pre steps 415 are further categorized into manual pre steps 420 and automated pre steps 425. The tasks in manual pre steps 420 are initiated by a user and tasks in automated pre steps 425 are initiated by the enterprise system.

Similarly, tasks in post steps 430 are categorized into manual post steps 435 and automated post steps 440. The tasks in manual post steps 435 are initiated by the user and the tasks in automated post steps 440 are initiated by the enterprise system. The tasks in task list 405 are displayed in an order of execution of a task. User interface 400 also provides information regarding a task. In an embodiment, the information regarding the task is provided in a pop up window 450 and the pop-up window 450 may be displayed by clicking button 445. Pop-up window 450 provides information such as a location of a software product, a summary of an execution of the task, details of an error fix, and a name of a system to which the software product belongs.

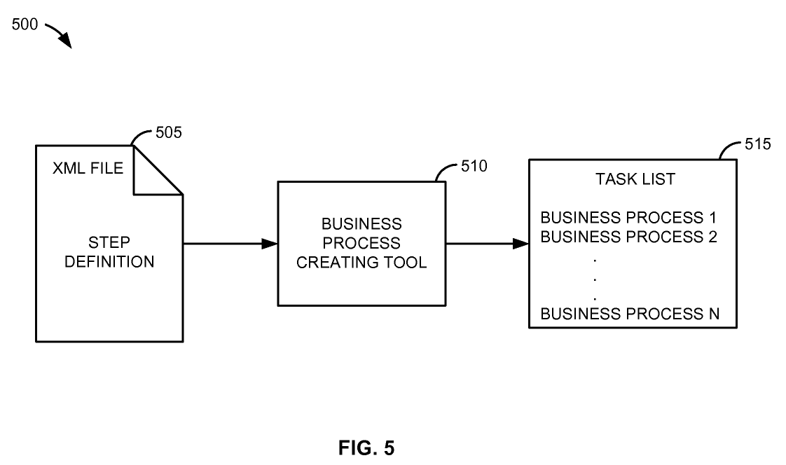

FIG. 5 is a block diagram of a business process creating tool to generate a task list of business processes executable in the enterprise system according to an embodiment of the invention. System 500 includes XML file 505 that contains a definition of a step of a business scenario. XML file 505 is imported into business process creating tool 510 and business process creating tool 510 converts a step in XML file 505 to a business process executable in the enterprise system. Task list 515 containing a list of business processes executable in the enterprise system is generated by business process creating tool 510.

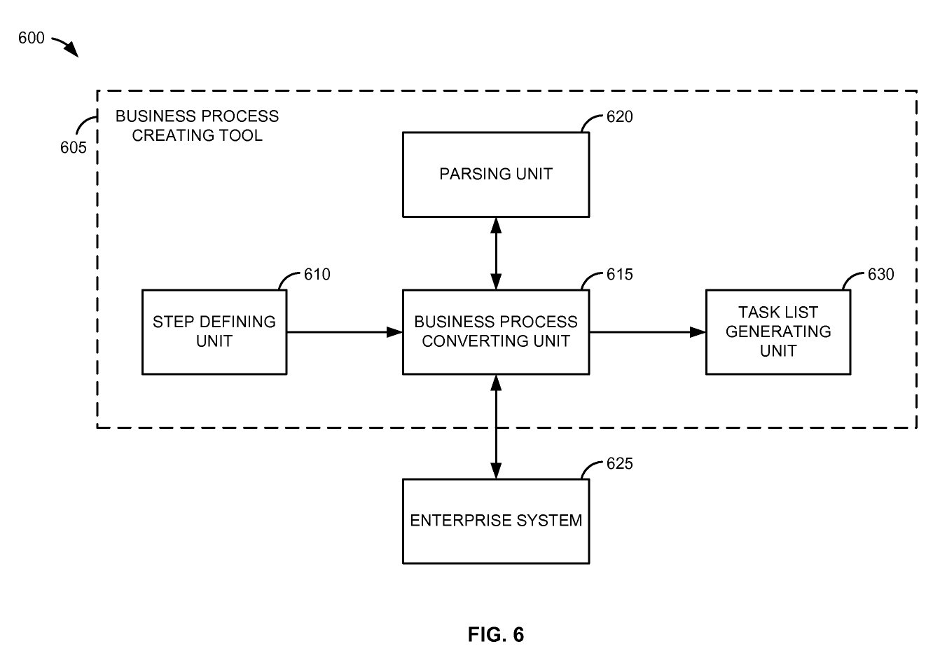

FIG. 6 is a detailed block diagram of various components of a business process creating tool to generate a task list of business processes executable in the enterprise system according to an embodiment of the invention. System 600 includes a business process creating tool 605 that converts a step of business scenario defined in XML file 505 to a business process executable in the enterprise system. Business process creating tool 605 includes a step defining unit 610 that defines the step of the business scenario in a file such as XML file 505. Step defining unit 610 determines various attributes of the step such as a type of the step, a name of the step, an execution type of the step, an execution order of the step, an application to which the step belongs and a component to which the step belongs.

Business process converting unit 615 electronically coupled to step defining unit 610 converts XML file 505 to the business process executable in enterprise system 625. Parsing unit 620 electronically coupled to business process converting unit 615 parses XML file 505 and retrieves attributes of the step such as the type, the name, the execution type, the execution order, the application to which the step belongs and a component to which the step belongs. Business process converting unit 615 identifies the business process in enterprise system 625 based on the attributes such as the type, the name, the application and the component retrieved from parsing unit 620. Similarly, business process converting unit 615 converts all steps of the business scenario defined in XML file 505 to a set of business processes executable in enterprise system 625.

Task list generating unit 630 electronically coupled to business process converting unit 615 generates task list 515 that contains a list of business processes of the business scenario. Task list 630 may be modified in a number of ways such as by including an additional business process that may not be defined in XML file 505, by removing a business process from task list 515 and by modifying an existing business process itself. The business process in task list 515 may be modified by modifying attributes such as execution order, execution runtime, and input parameters.

In an embodiment, step defining unit 610, business process converting unit 615, enterprise system 625 and task list generating unit 630 may be electronically coupled in various ways to achieve a result same as the one achieved in FIG. 6.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components.

Embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or any other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A method, comprising:
defining a step of a business scenario;
converting the step to a business process executable in an enterprise system; and
generating a task list containing a list of business processes in the business scenario.

2. The method in claim 1, wherein defining a step comprises determining an attribute of the step selected from a group consisting of a name of the step, a type of the step, an execution type of the step, an execution order of the step, an application to which the step belongs and a component to which the step belongs.

3. The method in claim 1, wherein defining a step comprises defining the step in a file format that includes extensible markup language (XML).

4. The method in claim 1, wherein converting the step to a business process comprises:
parsing a file containing the step;
retrieving a name of the step, a type of the step, an application to which the step belongs and a component to which the step belongs; and
identifying the business process in the enterprise system based on the name, the type, the application and the component.

5. The method in claim 1, wherein generating a task list comprises generating the task list containing the list of the business processes sorted in an order of execution.

6. The method in claim 1, wherein generating a task list further comprises generating a report of execution of the business process.

7. The method in claim 1, wherein generating a task list comprises importing a file containing the step of the business scenario.

8. A system, comprising:
a step defining unit to define a step of a business scenario;
a business process converting unit electronically coupled to the step defining unit to convert the step to a business process executable in an enterprise system; and
a task list generating unit electronically coupled to the business process converting unit to generate a task list containing a list of business processes.

9. The system in claim 8, wherein the business process converting unit comprises a parsing unit to parse a file containing the step of the business scenario.

10. The system in claim 8, wherein the business process converting unit is electronically coupled to the enterprise system to identify the business process in the enterprise system based on a name of the step, a type of the step, an application to which the step belongs and a component to which the step belongs.

11. The system in claim 8 further comprising a scheduler to execute the business processes in an order of execution defined in the step.

12. An article of manufacture, comprising:
a machine readable medium having instructions which when executed by a machine cause the machine to:
define a step of a business scenario;
convert the step to a business process executable in an enterprise system; and
generate a task list containing a list of business processes in the business scenario.

13. The article of manufacture in claim 12, wherein the machine readable medium provides instructions, which when executed by a machine cause the machine to determine an attribute of the step selected from a group consisting of a name of the step, a type of the step, an execution type of the step, an execution order of the step, an application to which the step belongs and a component to which the step belongs.

14. The article of manufacture in claim 12, wherein the machine readable medium provides instructions, which when executed by a machine cause the machine to
parse a file containing the step; and
retrieve a name of the step, a type of the step and an application component to which the step belongs; and
identify the business process in the enterprise system based on the name, the type, the application and the component.

15. The article of manufacture in claim 12, wherein the machine readable medium provides instructions, which when executed by a machine cause the machine to define the step in a file format that includes XML.
